(19) United States
(12) Patent Application Publication
(10) Pub. No.: US 2007/0131517 A1
(43) Pub. Date: Jun. 14, 2007

(54) Device for checking the authenticity of a monetary medium

(75) Inventor: Hans-Gunter Voss, Paderborn (DE)

Correspondence Address: HARNESS, DICKEY & PIERCE, P.L.C., P.O. BOX 828, BLOOMFIELD HILLS, MI, 48303, US

(73) Assignee: Wincor Nixdorf international GmbH

(21) Appl. No.: 11/585,313

(22) Filed: Oct. 23, 2006

(30) Foreign Application Priority Data
Dec. 14, 2005 (DE) 10 2005 059 797.1

(51) Int. Cl. G07F 7/04

(52) U.S. Cl. 194/206

(57) ABSTRACT

A device for checking the authenticity of a monetary medium, in particular a banknote 1, a bank card or a credit card, comprises a sensor arrangement 2 with a sensor 38 with a test area for checking physical or chemical properties of a medium of monetary value, and a transportation apparatus 3 for transporting the medium 1 of monetary value past the test area of the sensor 38. The sensor 38 is arranged such that it can move in relation to the transportation apparatus 2, so that it can scan the medium 1 to be checked by means of test tracks of different geometries.

### BACKGROUND OF THE INVENTION

1. Technical Field

The present invention relates to a test device for checking the authenticity of a monetary medium, in particular a banknote, a bank card or a credit card, having a sensor with a test area for checking physical or chemical properties of a monetary medium.

2. Discussion

If the monetary media are banknotes, devices of this type are used, for example, in cash-depositing machines, in cash-counting machines or in so-called “pay machines” from which, for example, travel tickets can be acquired or parking fees can be paid. The purpose of these test devices is to prevent counterfeit banknotes from being used.

If the monetary medium is a bank card, devices of this type are required, for example, in card-reading devices of cash machines in order to prevent a counterfeit bank card being used. This is important particularly because criminals have recently been increasingly able to extract data from magnetic strips of third parties by using so-called “skimming apparatus” and using said data on a counterfeit card in order to gain access to the account of the third party. A device for checking the authenticity of bank cards is therefore required.

Physical or chemical properties on the monetary medium can be checked by a sensor. Such properties include, in particular, optical, spectroscopic, electrical or magnetic properties of the monetary medium, which properties cannot readily be reproduced by a counterfeiter. Properties of this type which can be checked by the sensor are in general called “security features” of the monetary medium in this document. Said security features are particularly those which are present on the entire surface area of the monetary medium.

The monetary medium is usually guided past the test area of the sensor, and the sensor checks that portion of the monetary medium which is opposite the test area. In the case of small sensors, a narrow, rectilinearly running track is therefore produced, in which track the monetary medium is checked for authenticity.

This is illustrated in FIG. 2. The region of the banknote 1 which is checked by the sensor is denoted as sensor path 12. Since only the narrow strip along the sensor path 12 is checked in a device of this type according to the prior art, criminals have come up with the idea of counterfeiting the banknote 1 by using only a narrow strip 14 (hatched region in FIG. 2) from an authentic banknote and adding imitation material to the remainder in order to form a counterfeit banknote. If the security feature is a feature which is provided on the entire surface area of an authentic monetary medium, an authentic medium can be cut into a large number of strips which can then be used to produce counterfeit media which would all be identified as being authentic by the prior art device.

One possible option for preventing such misuse involves providing a surface-area sensor which checks the entire surface area of the monetary medium. However, a surface-area sensor of this type is very cost-intensive compared to a sensor with a small test area.

### SUMMARY OF THE INVENTION

In accordance with the teachings of this invention, the test device comprises a sensor which is arranged such that it can move in relation to the transportation apparatus for transporting the monetary medium. Since the sensor is arranged such that it can move, sensor paths which, for example, have curved, circular or sawtooth-like geometries can scan the banknote in a two-dimensional manner instead of the rectilinear sensor path 12 as seen in FIG. 2. In particular, the respective test track can be selected randomly, so that the specific test route cannot be predicted. It is therefore also possible to successfully check the authenticity of banknotes comprising authentic constituent parts and counterfeit constituent parts using sensors with a small test area or field of view. At the same time, the mobile arrangement of the sensor can be achieved with a very small amount of outlay on design, so that the costs of the device are not considerably increased.

In one particularly advantageous development, the sensor movement is a periodic movement, in particular a circular movement. A circular movement, in particular, can be realized in a relatively simple and cost-effective manner which causes little wear in the process.

In the case of a periodic movement, in particular a circular movement, the deviation of the sensor paths for two monetary media which are to be checked in succession can be produced in a simple manner by a phase difference in the periodic movement.

### BRIEF DESCRIPTION OF THE DRAWINGS

Further advantages and features of the present invention can be found in the following description which explains the invention using one exemplary embodiment with reference to the attached drawing, in which

FIG. 1 shows a schematic side view of a test device for checking the authenticity of a banknote,

FIG. 2 shows a banknote which is scanned by a rectilinear sensor path, and

FIGS. 3 to 6 show banknotes which are scanned with sensor paths of different geometries.

### DESCRIPTION OF THE PREFERRED EMBODIMENTS

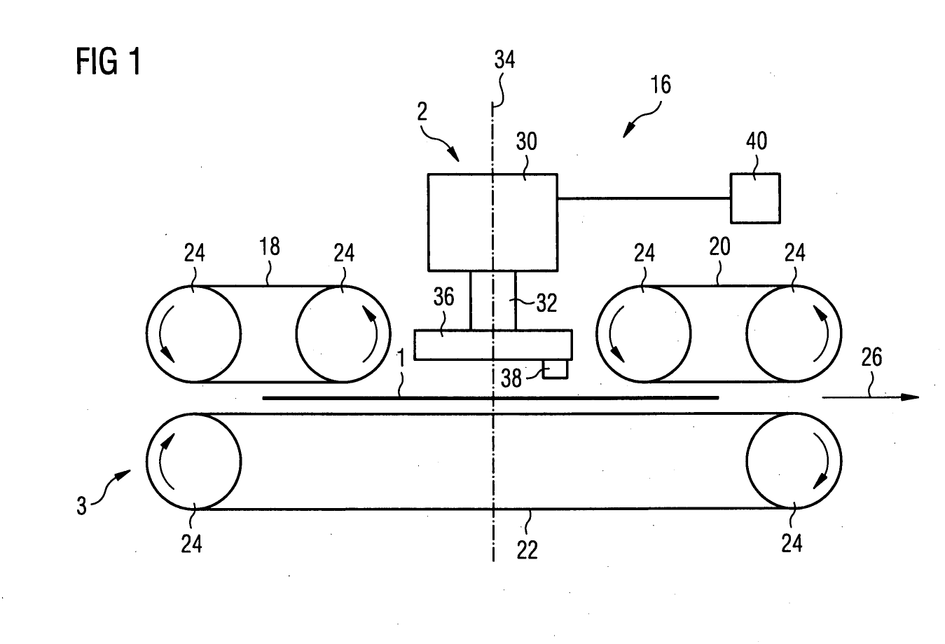

FIG. 1 illustrates a schematic side view of a device for checking the authenticity of a banknote 1. The device comprises a sensor arrangement 2 and a transportation apparatus 3 for transporting the banknote 1 past the sensor arrangement 2. The transportation apparatus 3 is, for example, in the form of a belt transportation means comprising three transportation belts or transportation-belt groups 18, 20 and 22 which are each tensioned between two rollers 24. In the illustration of FIG. 1, the leading end of the banknote 1 is held between the belt 20 and the belt 22 and the trailing end of the banknote 1 is held between the belt 18 and the belt 22. (The distances between the belts and between the banknote and the belts are illustrated on an enlarged scale in the schematic illustration of FIG. 1 for the sake of clarity.) As a result of rotation of the rollers 24 in the direction of the respective arrows, the banknote 1 is securely guided between the belts 18 and 20 on the one hand and the belt 22 on the other and transported in the direction of the arrow 26 at a speed v.

The sensor arrangement 2 has a motor 30 which rotates a vertical shaft 32 about the axis 34 (illustrated by a dashed line) which is located between the belts 18 and 20. A horizontal disk 36 is expediently fixed to the lower end of the shaft 32, and a sensor 38 with a test area (field of view) is eccentrically fixed to said horizontal disk. The sensor 38 has a test area for checking security features of the banknote 1 and has a small surface area overall. In the present description, the term “test area” refers, in particular, to a portion of the surface area of the monetary medium which is situated opposite the sensor and can be checked by the sensor, i. e., in the field of view of the sensor. As shown in FIG. 1 the field of view of sensor 38 is considerably smaller than the surface area of the entire banknote 1.

The sensor arrangement 2 also comprises an electronic control unit 40 for driving the motor 30 which causes the horizontal disk 36 and therefore the sensor 38 to perform a rotary movement.

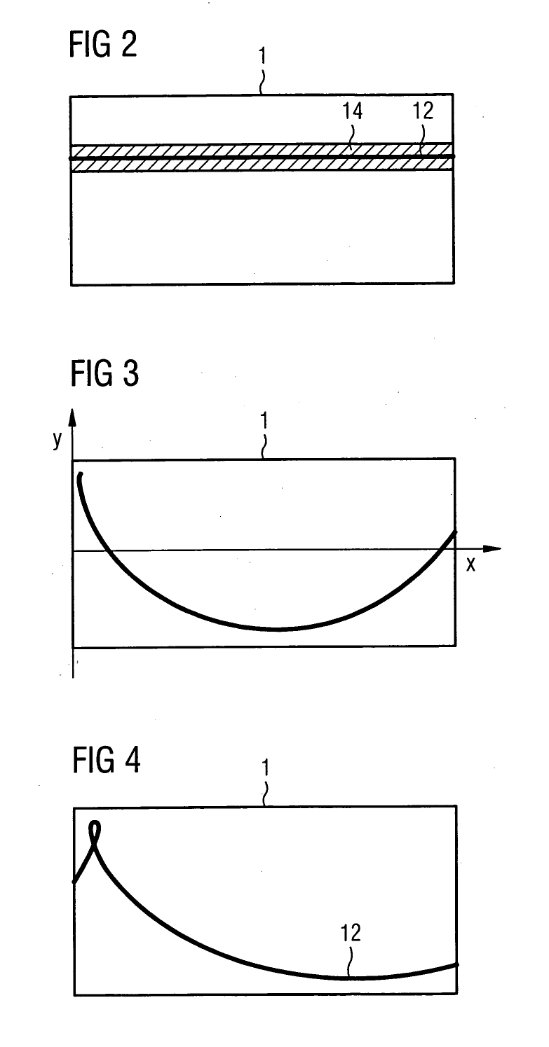

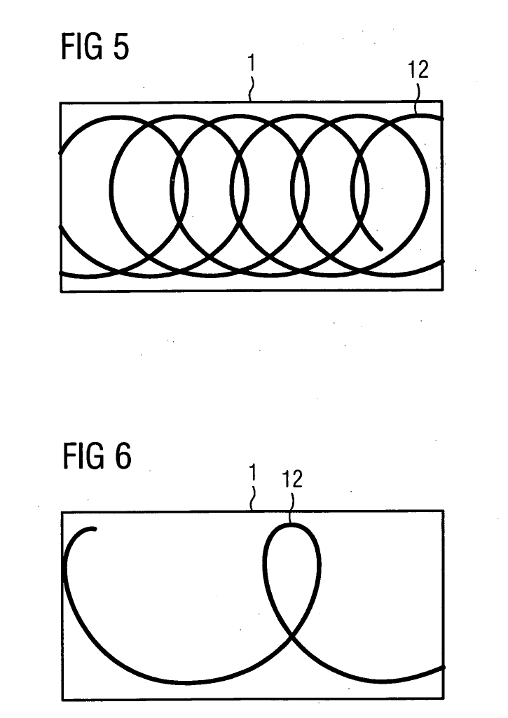

The banknote 1 is transported in the direction of the arrow 26 at a speed v until the leading end of the banknote 1 is positioned opposite the test area of the sensor 38. The sensor 38 can only check that portion of the banknote 1 which is positioned opposite the test area. Since both the banknote 1 and the sensor 38 move, sensor paths 12, as illustrated by thick black lines in FIGS. 3 to 6, are produced as a function of the rotational speed of the disk 36 and the distance of the sensor 38 from the axis of rotation 34.

Whereas it is still relatively easy to produce a counterfeit banknote 1 which contains an inserted strip 14 from an authentic banknote for the straight line sensor path 12 of FIG. 2 which is produced with a conventional device, it is far more difficult for the sensor paths 12 of FIGS. 3-6 since they have a more complicated profile.

In a further development of the invention, different sensor paths 12 can be provided for each banknote. In the present exemplary embodiment, this is produced by a shift in phase between the sensor paths 12 for successive banknotes. FIG. 4 shows the phase path 12 for a banknote 1 which has been tested immediately after the banknote 1 of FIG. 3, that is to say without the sensor 38 having rotated further between the two checking operations. Since the length of the checking operation (that is to say banknote length/v) in the exemplary embodiment shown is not an integral multiple of the period of the circular movement of the sensor 38, a sensor path 12 which differs from that of FIG. 3 is produced for the following banknote 1 of FIG. 4.

However, it is also possible to maintain the circular movement of the sensor 38 during two checking operations. The phase shift between two successive sensor paths 12 then depends on the time interval between when two successive banknotes 1 are input. If said banknotes are input by hand, this results in a phase relationship which is difficult to monitor, and therefore an unpredictable sensor path 12.

FIG. 5 and FIG. 6 show sensor paths 12 in which the angular frequency ω of the circular movement of the sensor 38 has been increased to four times and, respectively, two times that of the sensor paths of FIG. 3 and FIG. 4. It is clear from these figures that different regions of the banknote 1 can be checked by the sensor 38 as a result of suitable selection of the angular frequency ω of the sensor movement.

In one advantageous development, the electronic control unit 40 drives the motor 30 such that the sensor path 12 covers predetermined portions of the banknote 1 on which isolated security features are formed. As a result, it is possible not only to check those security features which are present over the entire surface area of the banknote 1 but isolated security features can also be deliberately approached and checked.

The electronic control unit 40 can also drive the motor 30 in such a way that the starting phase value φ of the relative movement of the sensor is set, the frequency ω of the sensor movement is varied and/or the direction of movement of the motor 30 is reversed.

What is claimed is:

1. A device for checking the authenticity of a monetary medium (1), in particular a banknote, a bank card or a credit card,
having a sensor arrangement (2) with a sensor (38) with a test area for checking physical or chemical properties of a monetary medium (1)
and having a transportation apparatus (3) for transporting the monetary medium (1) past the test area of the sensor (38),
characterized in that the sensor (38) is arranged such that it can move in relation to the transportation apparatus (3).

2. The device (16) as claimed in claim 1, in which the sensor (38) is suitable for checking optical, spectroscopic, electrical or magnetic properties of the monetary medium (1).

3. The device (16) as claimed in claim 1, characterized in that the sensor arrangement (2) has movement means which can be moved in the X and Y direction and to which the sensor (38) is connected.

4. The device (16) as claimed in claim 1, characterized in that the sensor arrangement (2) has, in particular rotatable, movement means which can be driven periodically and to which the sensor (38) is connected.

5. The device (16) as claimed in claim 4, characterized in that the rotatable movement means comprise a rotatable disk (36) which can be driven by a motor (30) and on which the sensor (38) is eccentrically arranged.

6. The device as claimed in claim 5, characterized in that the sensor movement is a circular movement.

7. The device (16) as claimed claim 1, in which scanning curves (12) of the sensor (38) for two monetary media which are to be checked in succession differ from one another.

8. The device (16) as claimed in claim 1, in which the movement of the sensor (38) can be controlled by an electronic control unit (40).

9. A device for checking the authenticity of a monetary medium, comprising:
a sensor arrangement with a sensor with a test area for checking security features of the monetary medium;
a transportation apparatus for transporting the monetary medium past the test area of the sensor, and
a rotatable mechanism, said sensor being fixed to the rotable mechanism so that the sensor scans for the security features along a curved sensor path as the monetary medium passes by the sensor whereby a relatively inexpensive sensor with a small field of view can be used to scan a varied surface of the monetary medium.

10. The device of claim 9 wherein the sensor is driven periodically by the rotatable mechansim.

11. The device of claim 9 wherein the rotatable mechanism comprises a rotatable disk driven by a motor and on which the sensor is eccentrically arranged.

12. The device of claim 11 wherein the sensor is rotated in a different pattern during the checking of successive monetary medium.
